(19) United States
(12) Patent Application Publication
(10) Pub. No.: US 2009/0297825 A1
(43) Pub. Date: Dec. 3, 2009

(54) Packing material which absorbs shock by injected air and a method thereof

(76) Inventors: Yeoung-Seok Kim, Seoul (KR); Yong-Ho Yun, Kyounggido (KR)

Correspondence Address: W. NORMAN ROTH, 523 W. 6TH STREET, SUITE 707, LOS ANGELES, CA, 90014, US

(21) Appl. No.: 11/628,187

(22) PCT Filed: Sep. 2, 2004
(86) PCT No.: PCT/KR04/02226

§ 371 Date: May 27, 2009

(30) Foreign Application Priority Data
Jun. 4, 2004 (KR) 10-2004-0041069
Sep. 2, 2004 (KR) 20-2004-0025197

(51) Int. Cl. B32B 7/14; B32B 37/00

(52) U.S. Cl. 428/317.1; 156/290

(57) ABSTRACT

The present invention relates to the buffer material used for the package of an article, and with the overlapped plastic film being stickig and having the air pocket while SAM of the air is prevented with the injected pneumatic pressure in which especially, the repetition injection of the air is possible and, the productivity is improved.

Presently, if a thing and the long time thereafter that it measures and it is impossible to the injection in which various kinds of things are developed as the buffer material which has the buffer force in a package while being expanded by the aerial pressurizing but which such most of the things injects the single air go by, the leak of the air is generated to the change of the external environment.

The valve film adheres closely with the pressure of the air injected in the state where the air passage forms on the part in which the air is injected and the air is injected in the air pocket to one side of the air pocket, the conventional problem is solved.

### TECHNICAL FIELD

The present invention relates to the buffer material used for the package of an article, and it uses as especially, the alternative of a styrofoam. Therefore, the plastic film is used to be expanded by the aerial pressurizing. In case it was generated that the expanded air pocket exploded of a one, it prevents to be muddy with the air bar. Consecutive even when a reinfusion is facilitated in the state where the air is injected, SAM of the air is prevented.

### BACKGROUND ART

Presently, while after publishing the valve film overlapped to the inner side of the plastic packing film which as shown in the figure, is overlapped to the thing for having the buffer force in a package while the air pocket is expanded by the aerial pressurizing, a street by an adhesion is formed, the direction of the valve film corresponding to is not adhered and it is adhered only the inner side of the plastic film and outer side surface of the valve film, the air is injected through the valve film.

At this time, if in case such air pocket is enumerated to a plurality of, the separate air passage is formed, the air is injected to one air supply nozzle, the air is injected to each air pocket.

At this time, it becomes so that the releasing layer is formed into the inner side of the packing film for the implementation of the air passage, an adhesion be comprised. At the same time, the releasing layer is formed on the valve film, an adhesion is not made.

As to the formation of this releasing layer, the various method for doing in order not to be adhered can be applied as a mode by a printing in other words.

But since the advantage of such thing has the advantage in which the leak of the consecutive air is not generated in spite of bursting into eruption of one and the advantage in which the leak of the air through the valve film is not easily generated relatively because the valve film is small, on the other hands, each valve film has to be inserted in each air pocket the advantage has to It be difficult on a task.

Therefore, it has the disadvantage that it without exception bursts into eruption by bursting into eruption of one and the disadvantage that the leak of the air increases as that because it can plan the improvement of the productivity in case of it reports between the packing film which is overlapped after forming the releasing layer on the valve film into one body and it forms a street by an adhesion, forming the air pocket but the valve film is formed in the top end portion whole of the air pocket.

This is considered to involve the problem the air escape which is serious in the interval of the releasing layer and street by forming the street which meets at right angle, is adhered to the releasing layer in the overlapped valve film after reporting the above-described valve film between the packing film after forming continuously the releasing layer, is due to be generated, and that the continued releasing layer bursts due to the series in case one air pocket bursts into eruption by being used as the air passage.

### DISCLOSURE OF THE INVENTION

Therefore, as to the present invention, in order to solve the above-described conventional problem, it devises. In case it sticks the valve film to one side of the packing film, the air is charged, since the valve film is tightly pressed it prevents the air escape with the expansion of the air pocket to the increment of the surface tension. The air does so that the air be generated that the air pocket bursts into eruption at the same time, although the air pocket bursts into eruption of one while preventing the air escape since it prevents the air supply nozzle while the air pocket is expanded if after forming continuously the releasing layer, it sticks the valve film and packing film to the valve film to the same cord as the releasing layer and it forms the bond line, it injects the air. By implementing the air passage while the bond line is held up with this adhesion if the air pocket is expanded by the aerial pressurizing the reinfusion of the air is possible.

### BRIEF DESCRIPTION OF THE DRAWINGS

FIG. 1 is an isolation perspective view showing the trim placing of a loosefill.

FIG. 2 is a plane view of the state where the dimorphism band and released surface are formed in the valve film.

FIG. 3 is a plane view showing the adhered state.

FIG. 4 is a cross-sectional view of the state where the air pocket is charged with the air.

FIG. 5 is an enlarged sectional view of the state where the air passage is formed.

FIG. 6 is a perspective view showing the appearance state.

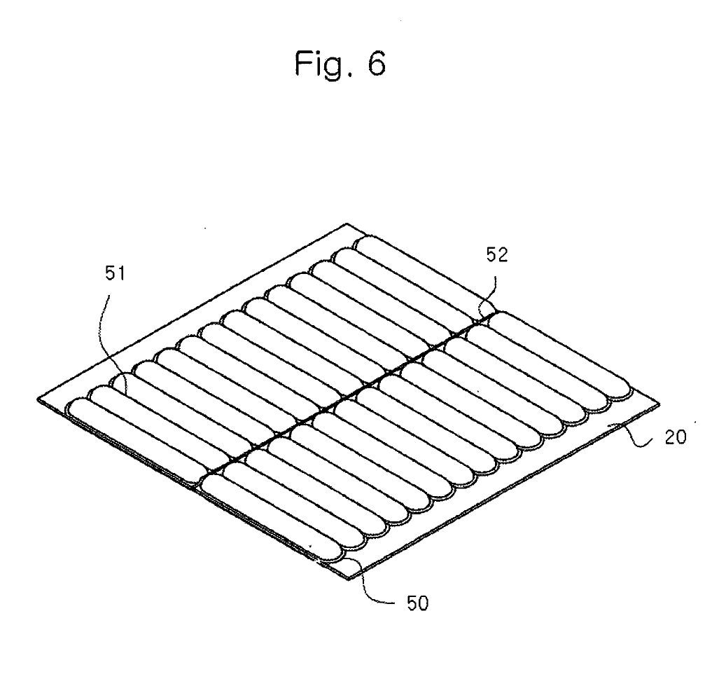

FIG. 7 is a cross-sectional view of the state where a valve is located in the conventional air pocket.

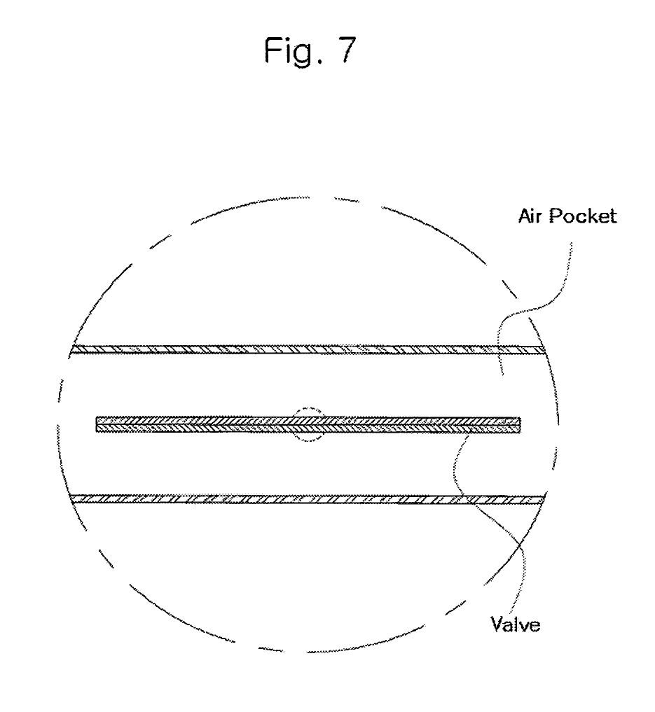

### MODES FOR CARRYING OUT THE INVENTION

Hereinafter, the most preferable embodiment of the present invention decides to be circumstantially illustrated with reference to the attached view. Firstly, each drawing was illustrated. Even if it was limited to the same element as the conventional technology or the elements corresponding to, it had the different reference numeral.

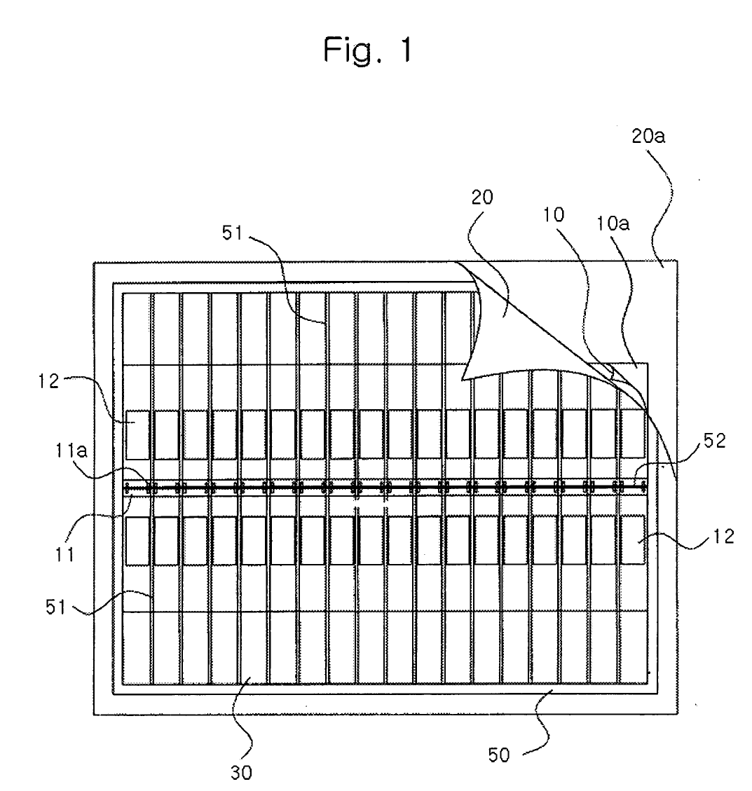

As shown in FIG. 1, as to a configuration, after reporting overlapped valve films (10,10a) having the dimorphism band (11) to the inner side, it sticks the outer ring of packing films (20,20a) to the interval of overlapped packing films (20,20a) having an outline in order to have the formation of cargo according to the form of an article and the interval forms the adhesion line (50). It meets at right angle with the dimorphism band (11), the division line (51) of the multiple heat is formed as the inner side of the adhesion line (50) and the interval forms each air pocket (30). The air supply nozzle (31) is formed with the dimorphism band (11) which is not adhered by the upper of the air pocket (30). It sticks to the cord which is identical to the upper of the dimorphism band (11) of the dimorphism band and it forms the bond line (52), the interval makes adhered.

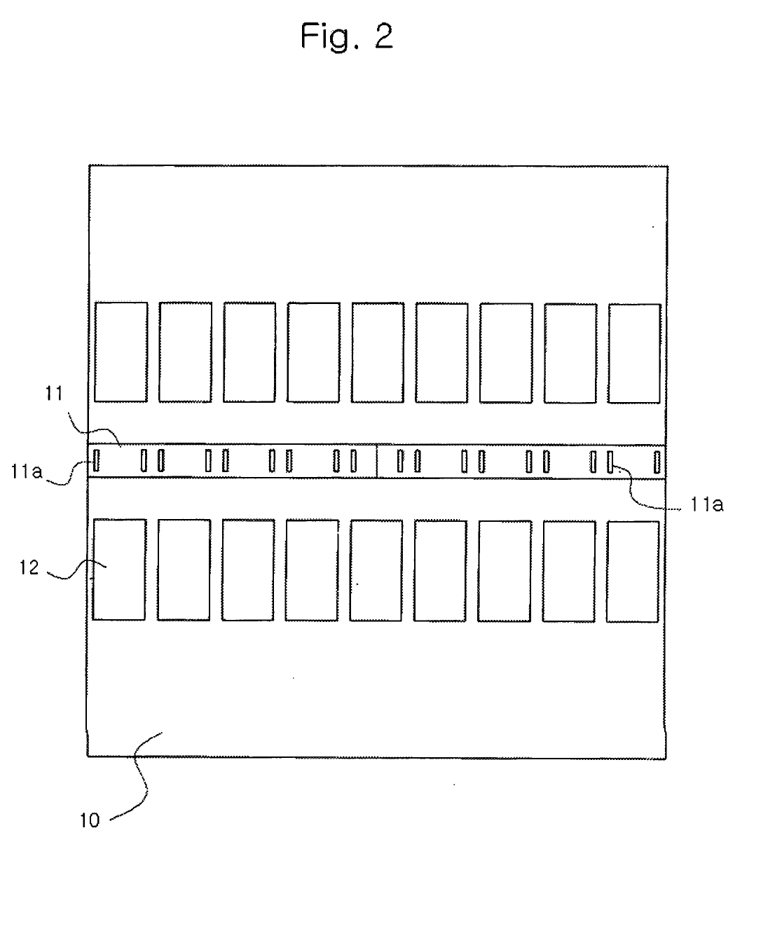

At this time, as shown in FIG. 2, in one side of the valve film (10), the continued dimorphism band (11) is formed and the released surface (12) having the fixed area is formed on the other side face to be arranged as the constant interval and after the dimorphism band (11) is located in the inner side, and, the other valve film (10a) is overlapped.

Moreover, in the dimorphism band (11), while looking around the exact location with the released surface (12) in case of the confirmation line (11a) is formed for the exact location confirm forming the division line (51), forming the division line (51), it works.

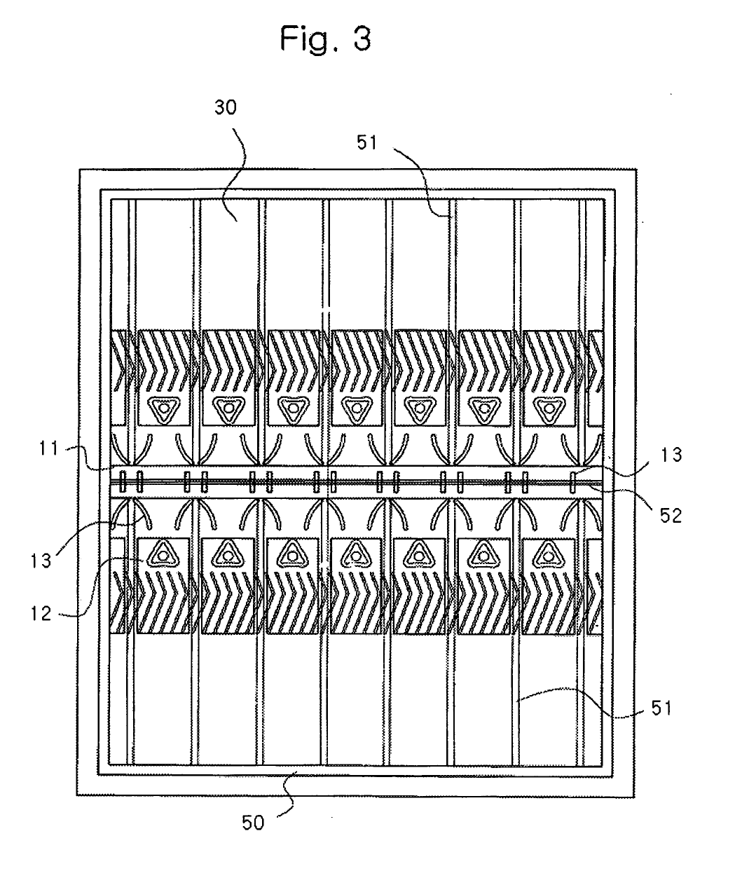

In this way, in the arranged state, after reporting overlapped valve films (10,10a) in the in-between of overlapped packing films (20,20a), as shown in FIG. 3, the dispersion bond line (15) as well as the guide bond line (13) preventing the reverse current and guide adhesive part (14) are formed at the state that is injected to one task while making the flow of the air injected to the air pocket (30) as well as the adhesion line (50) and division line (51) and bond line (52) smooth.

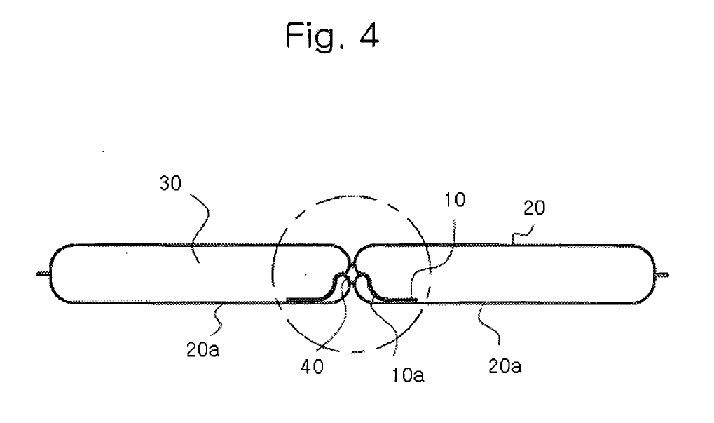

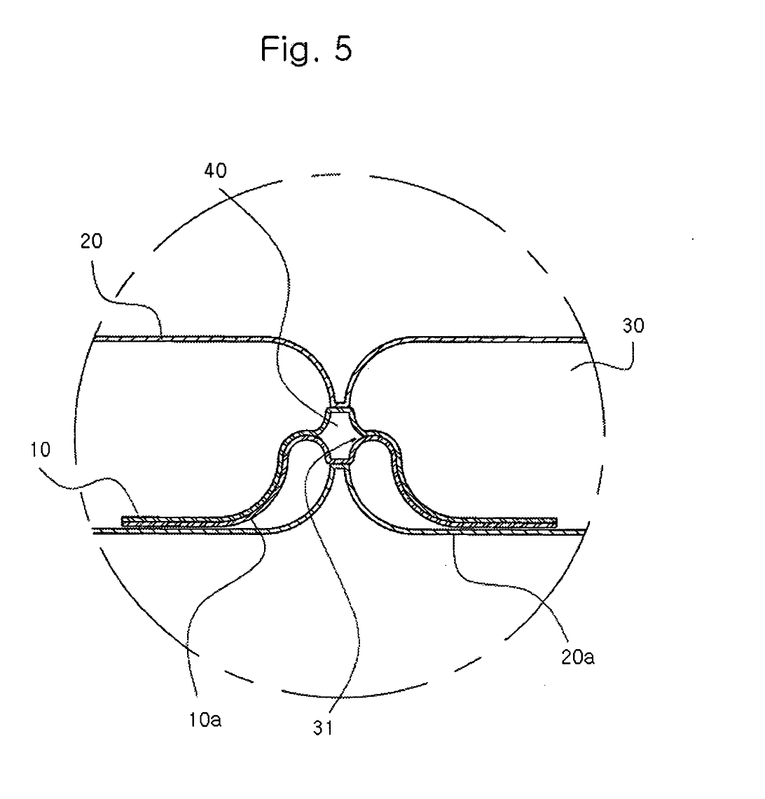

At this time, as shown in FIGS. 4 and 5, is close of the air supply nozzle (31) that it is blocked in case the air is injected in the air pocket (30) and the air is expanded and it makes facilitated, the guide bond line (13) formed as the inner side at the bottom of the dimorphism band (11) in which each division line (51) is formed for the flowing backward prevention forms to be bent. While the air supply nozzle (31) is expanded if the air pocket (30) is expanded with the aerial pressurizing at the same time, since packing films (20,20a) and valve films (10,10a) are adhered by being located in the part without the released surface (12), this guide bond line (13) is strongly blocked.

Moreover, as to the guide adhesive part (14) formed in the bottom of the guide bond line (13), one side is fixed so that valve films (10,10a) which are overlapped while it is positioned in the released surface (12), it is adhered in one side of the packing film (20a) only one side of the valve film (10a) be located in one side of the packing film (10a).

As to this adhesion fixing, valve films (10,10a) which are overlapped since the injected pneumatic pressure acts on one side of valve films (10,10a) with bay if the air is injected to the interval of valve films (10,10a) which are overlapped in case the air is injected in the air pocket (30) does not take place and it adheres closely to one side of the packing film (20a).

Therefore, since it is not generated to take place of overlapped valve films (10,10a) the leak of the air is prevent.

Moreover, in this way, since the air injected through the dimorphism band (11) is not any more injected while each of the air pocket (30) is expanded if the air pocket (30) is charged with the air the injection of the air is accomplished in the air pocket (30) of the pressure which is same at all times. Since this air bulking the outer side surface of packing films (20,20a) and inner side of valve films (10,10a) are adhered by the upper of the dimorphism band (11) with the bond line (52) adhered by a co-linear the air supply nozzle (31) is closed by the expansion of the air pocket (30).

Moreover, as to such phenomenon, if it re-pours the air even in case the air comes off in the air pocket with the bond line (52) of the dimorphism band (11) in the direct image lower part of the bond line since the air passage (40) having the fixed space is formed, in conclusion, that is, the closing of the air supply nozzle (31) of the air pocket (30) corresponding to the pressure of the fixed air is filled by the difference of the pneumatic pressure.

Moreover, after so that valve films (10,10a) and packing films (20,20a) closely adhere closely, a plurality of dispersion bond lines (15) is formed into the guide adhesive part (14) and bottom, the air is smoothly injected, it prevents from valve films (10,10a) taking place.

Therefore, if the air is injected, while the air passage (40) is formed with the bond line (52) formed in the upper of the dimorphism band (11) into the shear of the air supply nozzle (31) of the air pocket (30) if the air is injected to each air pocket (30) while the air is injected through the dimorphism band (11), the air is facilitated, the air is injected. While the air supply nozzle (31) is blocked if the some injection is completed, the air is not any more injected.

Moreover, in the state where the air is injected, since valves (10,10a) which are overlapped since valve films (10,10a) overlapped with the pneumatic pressure of the air pocket (30) more adhere closely with the inner side of the packing film (20a) because valve films (10,10a) which are overlapped because the air pocket (30) is expanded one side adheres closely with the inner side of the packing film (20a) does not take place the leak of the air is not generated.

Moreover, in case the air to some extent came off in each of the air pocket (30) with such air passage (40), a recharge is possible with such air passage (40).

In the present invention, it is *** that Holotrichia is possible through the vinyl sheet illustrating as the plastic film in which the thickness is 200μ or less but has the plastic sheet or the vinyl group which is 200μ or greater according to the use or the used place.

Moreover, since one bonding process is manufactured with one bonding process the improvement of the productivity is ensured and the generation of a defect by the deformation of the film-type which can be generated with the repetition adhesion is prevented.

For this, firstly, after arranging with the step reporting valve films (10,10a) overlapped in the step overlapping and, the other valve film (10a) after the step forming the dimorphism band and released surface on the both sides of the valve film (10) between the packing film, one bonding process is manufactured with one bonding process.

At this time, an adhesion is manufactured to an adhesion by the heat but it is possible with the mechanical operation including the high frequency etc. The various mode this adhesion is applied.

Moreover, in the present invention, the packing film adheres the polyester film the form of a film in the nylon film in the inner side because of being the thermal adhesive. It is done by the polyester film, it uses the valve film that the same material is adhered with the heat.

But and, various materials of films which differentiate the adhesion form according to the method of an adhesion in case of using as the other method are used.

As described in the above, since the where the air is charged state is not generated to take place in the state of the valve film since the valve film is positioned in one side of the packing film the state nearly does not have the leak of the air. Since the bond line formed as the upper of the dimorphism band in a co-linear forms the natural air passage in case the air pocket is expanded by the aerial pressurizing the reinfusion of the air is possible.

What is claimed is:

1. The air injection type loosefill, wherein after reporting overlapped valve films (10,10a) having the dimorphism band (11) to the inner side, the outer ring of packing films (20,20a) is stickig to the interval of overlapped packing films (20,20a) having an outline in order to have the formation of cargo according to the form of an article and the adhesion line (50) is formed and the outer ring is formed so that the division line (51) of the multiple heat be crossed at the inner side of the adhesion line (50) toward the dimorphism band (11) and each air pocket (30) is formed; the bond line (52) is formed so that it sticks to the cord which is identical to the upper of the dimorphism band (11) of the dimorphism band and the outer side surface of valve films (10,10a) and inner side of packing films (20,20a) be adhered; and the constant interval is formed so that the released surface (12) having the fixed area be arranged in the other side face in which the dimorphism band of the valve film (10) is formed as the constant interval and the guide adhesive part (14) is formed, valve films (10,10a) are positioned in one side of the packing film.

2. The air injection type loosefill of claim 1, wherein in the dimorphism band (11), while looking around the exact location with the released surface (12) in case of the confirmation line (11a) is formed for the exact location confirm forming the division line (51), forming the division line (51), it works.

3. The air injection type loosefill of claim 1, wherein the guide bond line (13) is formed to be bent in the bottom of the dimorphism band (11) in which each division line (51) is formed.

4. The air injection type loosefill of claim 3, wherein in the guide bond line (13), by being located in the part without the released surface (12) at the same time, packing films (20,20a) and valve films (10,10a) are adhered.

5. The air injection type loosefill of claim 1, wherein the dispersion bond line is formed and the uniform dispersion of the air is made of the bottom of the guide adhesive part.

6. The air injection type loosefill of claim 1, wherein in the bond line of the dimorphism band, since the air passage occupying the constant space is formed in the dimorphism band in case the air supply nozzle is closed while the air pocket is expanded by the aerial pressurizing the reinfusion of the air is possible.

7. The air injection type loosefill manufacturing method, wherein it is positioned in one side of the packing film in which the valve film which at the same time, forms the dispersion bond line (15) as well as the guide bond line (13) preventing the reverse current and guide adhesive part (14) at the state that is to be overlapped a step reported in the in-between of packing films (20,20a) overlapped step: step: valve films (10,10a) overlaps the valve film (10a) includes the dimorphism band and released surface in one side and the other side face of the valve film (10): thing injected to one adhesion while making the flow of the air injected to the air pocket (30) as well as the adhesion line (50) and division line (51) and bond line (52) smooth, is overlapped is overlapped.

8. The manufacturing method of the air injection type loosefill of claim 7, wherein in the step equipped with the dimorphism band of the valve film, the step equipped with *** confirmation line is added to the dimorphism band.
